(19) United States
(12) Patent Application Publication
(10) Pub. No.: US 2019/0028192 A1
(43) Pub. Date: Jan. 24, 2019

(54) A METHOD AND SYSTEM FOR COMMUNICATION IN A WIRELESS NETWORK

(71) Applicant: PURELIFI LIMITED, Edinburgh (GB)

(72) Inventors: Dobroslav Tsonev, Edinburgh (BG); Stephan Berner, Sofia (DE)

(73) Assignee: PURELIFI LIMITED, Edinburgh (GB)

(21) Appl. No.: 15/759,024

(22) PCT Filed: Sep. 12, 2016
(86) PCT No.: PCT/GB2016/052817

§ 371 Date: Mar. 9, 2018

(30) Foreign Application Priority Data
Sep. 11, 2015 (GB) 1516148.2

(51) Int. Cl. H04B 10/116; H04W 56/00; H04L 1/18; H04W 72/04; H04L 5/14

(52) U.S. Cl. CPC H04B 10/116; H04W 56/0005; H04W 72/10; H04W 72/0453; H04L 5/14; H04L 1/1854

(57) ABSTRACT

A method and system for communication in a wireless network A method of communication in an optical wireless network, the optical wireless network comprising a first device, a plurality of further devices, and a common communication channel usable by any one of the further devices for sending data to the first device, wherein the method comprises sending, by at least one of the further devices, at least one control signal to the first device via at least one control channel; and allocating, by the first device, the common communication channel to one or more of the further devices, wherein the allocating is in response to the at least one control signal; wherein the sending of the control signal or at least one of the control signals by the further device or at least one of the further devices is substantially simultaneous with the sending of data via the common communication channel.

### FIELD

The present invention relates to a wireless communication method and system, for example a parallel control channel signalling method and system for a wireless optical network.

### BACKGROUND

It is known to provide wireless data communications by using visible light (or infrared or ultraviolet light) instead of radio frequencies to transmit and receive data wirelessly between devices. Data may be transmitted using light by modulating an intensity of the light. The light used may be coherent or incoherent. Methods that use light to transmit data wirelessly may be referred to as visible light communications (VLC) or optical wireless communications (OWC).

Wireless networks using visible light may in some circumstances allow a higher data capacity and greater energy efficiency than radio frequency wireless networks, and may also be used to replace point-to-point infrastructure in locations where conventional infrastructure does not exist or is too expensive to build.

A networked communication system may comprise an access point (AP) and several mobile stations (MS) which each communicate with the access point. The AP may send signals to the MSs over a downlink channel. The MSs may send signals to the AP over an uplink channel. The system may be a full-duplex system using separate and independent channels for the uplink and the downlink (for example, visible light transmission for the downlink and infrared transmission for the uplink).

Communication bandwidth may be shared between all MSs in both downlink and uplink. For example, all MSs may receive data from the AP on a common downlink channel. All MSs may send data to the AP on common uplink channel. A suitable protocol may be required to efficiently manage sharing of communication resources between different mobile users.

A networked communication system employing at least one AP that is expected to serve more than one MS at a time may require the exchange of control signals at a media access control (MAC) layer. The control signals may be used to facilitate the negotiation and use of a common resource (for example, the common uplink channel) by more than one user at a time (for example, more than one MS at a time). In known systems, control signals may be sent from the AP to the MSs using the common downlink channel. Control signals may be sent from MSs to the AP using the common uplink channel. Therefore, each of the common uplink channel and common downlink channel may carry both data communications and control signals.

An example of a control signal is a request to send (RTS). An RTS may be transmitted by a MS to an AP when the MS needs to transmit information over a communication channel (for example, the common uplink channel) that is shared between multiple users.

Upon receipt of one or more RTSs, the AP may make a decision regarding to which MS or MSs the resource should be allocated. The AP may correspondingly inform the MS or MSs to which the resource has been allocated that they are cleared to transmit on the common uplink channel. For example, the AP may send a clear-to-send (CTS) signal to the MS or MSs.

Another example of a control signal is a request by an MS to connect to an AP, thereby joining an existing network. By requesting connection to the AP, the MS may make the AP aware of its presence within the coverage area of the AP and its intention to take part in the communication protocol. Bi-directional control channel signalling may be used to perform association of the MS with the AP. For example, association may require communication of a control signal from the MS to the AP, and communication of a further control signal from the AP to the MS.

Other control signals may include, but are not limited to: signals that indicate the priority of a requested transmission, signals that negotiate link parameters, signals from the AP that grant permission for a given resource utilization, signals that inform the MSs of a predetermined transmission order, etc.

In a downlink scenario, a single AP may transmit data to (and possibly receive acknowledgements from) all MSs which fall within the AP's coverage area. The AP's coverage area may be a single optical attocell. An attocell may be a region of coverage that is smaller than a femtocell.

The AP may be aware of rates, timing constraints, and priorities required by the individual stations. In downlink, the AP may employ one of a number of multiple access techniques in order to communicate with multiple MSs. The AP may use a multiple access technique such as packet oriented multiple access, orthogonal frequency division multiple access (OFDMA), time division multiple access (TDMA), code division multiple access (CDMA), or any other suitable multiple access technique.

In a full-duplex system comprising a single AP and multiple MSs as described above, an uplink scenario may present a more complicated case than the downlink scenario. An uplink scenario may include the possibility that multiple MSs require transmission at the same time. Contention may occur when more than one MS is competing to use the uplink channel. A method may be required by which any possible contention between the individual users competing for the same transmission resources (the common uplink channel) may be handled efficiently.

In an example of a full-duplex system having separate uplink and downlink channels, contention may occur only in the uplink scenario. The AP does not have to compete with any further device for use of the downlink channel, since it is the only device transmitting on the downlink channel. However, the MSs may have to compete for use of the uplink channel.

A number of solutions exist for realizing multiple access in the uplink channel. Techniques used for realizing multiple access in the uplink channel may include packet oriented multiple access, OFDMA, TDMA, or CDMA, which are discussed in turn below.

In TDMA, time slots may be allocated by the AP to each MS that requires the uplink channel. TDMA may provide a fair allocation if there is no scheduling. However, the allocation may not be efficient. Resources allocated to idle MSs are not used. TDMA may require synchronization of MSs in time.

In frequency division multiple access (FDMA), bandwidth slots may be allocated by the AP to each MS that requires the uplink channel. Each MS may be allocated a different bandwidth slot within the frequency range covered by the uplink channel. However, in some circumstances, bandwidth used for communication may be limited by front-end components of the system. A frequency response of the system may fall off with increasing frequency. MSs that are assigned some bandwidth slots (for example bandwidth slots that are lower in frequency) may have an advantage over MSs that are assigned other bandwidth slots (for example, bandwidth slots that are higher in frequency). For example, MSs that are assigned lower-frequency bandwidth slots may experience higher signal-to-noise than MSs that are assigned higher-frequency bandwidth slots. It may be possible for analog design efforts to make an FDMA scheme fair. However, if a bandwidth slot is allocated to each MS whether or not it the MS is idle, resources allocated to idle stations cannot be utilized. The inability to utilize slots allocated to idle stations may result in efficiency being suboptimal.

In FDMA, guard intervals may be required between different bands. The use of guard intervals may decrease the overall efficiency of the scheme.

OFDMA may be considered to be similar to FDMA, but is realized in the digital domain using orthogonal frequency subcarriers. No guard intervals may be required between the communication bands because the orthogonal subcarriers may ensure that there is no interference between subcarriers. In some circumstances, requirements regarding synchronization in time and in frequency may make the use of OFDMA impractical for uplink. Without scheduling, the resources of the idle MSs may not be utilized, which may make the method less efficient.

In CDMA, each MS may be assigned a unique code which shapes its signal transmission to be orthogonal to the signal transmission of other MSs. In intensity modulation and direct detection (IM/DD) systems such as OWC systems and VLC systems it may be difficult to generate energy efficient unipolar orthogonal codes. Bandwidth limitation of the front-end components in an OWC or VLC system may make implementation of CDMA difficult. It is possible that orthogonal codes may become indistinguishable due to a limited frequency response of the front-end devices. The front-end components may not possess enough bandwidth for a spread-spectrum approach. Without scheduling, resources of idle MSs may not be used, which may make the method less efficient.

TDMA, FDMA, OFDMA and CDMA may each provide orthogonal multiple access. In orthogonal multiple access systems there may be no contention for resources. Methods such as TDMA, FDMA, OFDMA and CDMA may rely heavily on synchronization or spread spectrum techniques. Such synchronization or spread spectrum techniques may not be achievable on systems with limited front-end bandwidth.

In some circumstances, resource allocation in TDMA, FDMA, OFDMA and CDMA may be suboptimal since idle stations may not be utilizing the communication resources made available to them. The efficiency of the system may be improved by dynamic allocation of unused resource to MSs that could benefit from more communication capability. Improving efficiency may require the introduction of some form of scheduling algorithm for resource distribution. The introduction of such an algorithm may lead to contention for resources when more than one MS requires transmission at a given point in time. Algorithms such as Aloha, CSMA, CSMA/CD and token passing, as described below with their respective key characteristics, may be used to handle contention in multiple access techniques.

Aloha is a low complexity technique in which each MS transmits whenever data for transmission is available. After a transmission by an MS is over, if no acknowledgement of reception is sent by the AP, the MS assumes that a collision has occurred. The MS backs off for a random period of time and then repeats the transmission. Aloha may be simple and cheap to implement. Aloha may lead to collisions and may have low protocol efficiency. Transmission may often be disrupted in both half-duplex and full-duplex implementations of Aloha.

In some circumstances, the Aloha protocol may only work for a relatively small number of MSs. Improved variants of Aloha such as Slotted Aloha and Reservation Aloha exist. In Slotted Aloha, data may be transmitted only at the beginning of pre-determined slots in order to reduce collisions. In Reservation Aloha, slots may be reserved by transmitting stations. Collisions may still be an issue in protocol variants such as Slotted Aloha and Reservation Aloha.

Carrier sensing multiple access (CSMA) may be considered to be an improved version of the Aloha. In CSMA, each station listens to other stations to attempt to sense the use of the channel. In some full-duplex OWC systems in which one wavelength (for example, visible light) is used for the downlink and another wavelength (for example, infrared light) is used for the uplink, CSMA may require each MS to have hardware for reception in both the uplink direction and the downlink direction (i.e. each MS is capable of receiving both visible light and infrared light). In systems in which MSs cannot receive both uplink and downlink, collisions may be detected only by the AP. If collisions are only detected by the AP, the efficiency of the CSMA protocol may be reduced.

In OWC and VLC systems, line of sight (LoS) communication may be required for reliable signal detection. The field of view of the front-end component may be limited for practical considerations. The limited field of view may cause a transmitting MS to become invisible to other MSs. The transmitting MS becoming invisible may lead to a hidden node issue, which occurs when other stations cannot sense transmissions from the transmitting MS. Collisions may occur and may reduce efficiency.

Improved variants of CSMA exist, for example carrier sensing multiple access with collision detection (CSMA/CD) and carrier sensing multiple access with collision avoidance (CSMA/CA). CSMA/CD and CSMA/CD may suffer from efficiency reductions due to contention.

In a token passing method, stations may pass a token between each other. When a station chooses to seize the token, the token gives that station a right to transmit. A token passing method may require stations to be able to communicate with each other. If stations cannot communicate with each other, a token passing method may resemble a polling algorithm by the AP. In a full-duplex scenario in which MSs cannot listen to the uplink channel, and in OWC applications in which a connection between MSs may be physically impossible, it may be the case that a token passing technique can only be realized as a polling algorithm.

A token passing technique may result in fairness of resource allocation (for example, where a token is passed in a round-robin approach) and in some cases collisions may be avoided completely. However, idle stations may still be polled, which may reduce efficiency.

For a half-duplex system, which uses the same communication channel for both the downlink and the uplink, the contention issues described above may apply to both the uplink and the downlink scenarios, since the AP may be competing with the MSs for the same shared communication resource.

### SUMMARY

In a first aspect of the invention, there is provided a method of communication in a wireless network, the wireless network comprising a first device, a plurality of further devices, and a common communication channel usable by any one of the further devices for sending of data to the first device. The method comprises sending, by at least one of the further devices, at least one control signal to the first device via at least one control channel. The method may comprise allocating, by the first device, the common communication channel to one or more of the further devices, optionally for sending data to the first device, wherein the allocating is in response to the at least one control signal. The sending of the control signal or at least one of the control signals by the at least one of the further devices may be substantially simultaneous with sending of data via the common communication channel, for example by another one of the further devices.

The or each control channel may utilize spare communication capacity. The or each control channel may utilize capacity that is not used by the common communication channel. The common communication channel may be a primary information-bearing channel. The control channel may utilize capacity that is not used by the primary information-bearing channel due to practical reasons. The practical reasons may comprise at least one of insufficient signal to noise ratio, lower capacity.

A transmission or reception band of the first device or of the or each further device may be limited by hardware characteristics of the first device or of the or each further device. Hardware characteristics may comprise characteristics of at least one hardware component. Hardware characteristics may comprise at least one of a bandwidth of at least one hardware component, a response of at least one hardware component. The at least one hardware component may comprise at least one of a receiver, a transmitter, a filter, an analog filter, a digital filter, a light source, an LED, a front-end component.

The common communication channel may occupy a first part of the transmission or reception band and the at least one control channel may occupy a second, different part of the transmission or reception band.

The transmission or reception band may be a frequency band. The quality of the frequency band may vary with frequency across the frequency band.

The or each control channel may be selected to have lower quality than the common communication band.

The or each control channel may comprise a dedicated control channel that occupies a frequency range outside a frequency range that is occupied by the common communication channel. The or each control channel may occupy a region of bandwidth that is not used for data transmission.

By sending control signals using one or more control channels that are outside the common communication channel, more efficient use of the common communication channel may be achieved. Data transmission may be achieved with minimal overhead for the transmission of control signals. The common communication channel may be used for the communication of data while all or substantially all control signals may be transmitted on the at least one control channel. The control channels may occupy bandwidth that does not have high enough quality for the transmission of data, but does have high enough quality for the transmission of control signals. The first device may be aware of connectivity requirements of the further devices without interrupting upload or download of data to inspect the state of each of the further devices.

The method may provide efficient signalling of control information in baseband wireless systems in which the communication bandwidth is limited by hardware characteristics (for example, by the properties of front-end elements) and not by regulatory measures such as spectrum licensing.

The common communication channel may comprise a common uplink channel. The common communication channel may comprise a common downlink channel. Lower quality may comprise lower signal-to-noise ratio. The or each control channel may have a signal to noise ratio that is less than 90%, optionally less than 80%, optionally less than 50%, optionally less than 20%, of a signal to noise ratio of the common communication channel. Lower quality may comprise a lower capacity for information transfer. The or each control channel may have a capacity that is less than 90% optionally less than 80%, optionally less than 50%, optionally less than 20%, of a capacity of the common communication channel.

The wireless network may comprise an optical wireless network.

The sending of the at least one control signal by the at least one of the further devices may be substantially simultaneous with sending of data via the common communication channel by another one of the further devices.

The method may further comprise receiving by the first device the at least one control signal and the data from the other one of the further devices. The receiving of the at least one control signal may not interrupt the receiving of the data from the other one of the further devices.

The sending of the at least one control signal to the first device via the at least one control channel may comprise sending by a first one of the plurality of further devices a first control signal via a first control channel and sending by a second one of the plurality of further devices a second control signal via a second, different control channel.

The sending of the first control signal and the sending of the second control signal may be substantially simultaneous. The sending of control signals by a plurality of devices may occur without interruption of control signals and/or channels by other control signals and/or channels.

Sending a control signal from one device on one control channel and a control signal from another device on another control channel may allow the control signals to be sent simultaneously without collisions. Sending one or more control signals on one or more control channels while sending data from another device on the common communication channels may prevent collisions between the control signals and the data from the other device.

Allocating the common communication channel to one or more of the further devices may comprise allocating a respective communication resource on the communication channel to each of the one or more further devices. Allocating a communication resource may comprise allocating a slot. Allocating a slot may comprise allocating a time slot. The first device may be configured to allocate slots such that in any given slot, the communication channel is allocated to no more than one of the plurality of further devices.

By allocating slots to further devices in response to the control signals, and allocating each slot to no more than one device, the first device may ensure that substantially no collisions occur between transmissions from the further devices. The slots may be allocated for efficient use of the common communication channel.

The common communication channel may occupy a communication frequency band. The or each control channel may occupy a respective control frequency band outside the communication frequency band.

The or each control frequency band may be of higher frequency than the communication frequency band. In some systems, higher frequencies may have worse quality than lower frequencies. By using the higher, worse quality frequencies for the control channels, the lower, higher quality frequencies may be reserved for the communication of data while control signals are carried on the control channels.

In some networks, for example optical wireless networks, millimetre wave networks and terahertz networks, bandwidth of a system may be limited by characteristics of the system (such as frequency response or signal-to-noise) rather than by regulatory requirement. By using lower-quality parts of an available band for control signals, transmission of data on a high-quality part of the available band may not be interrupted.

The first device may comprise a receiver. The receiver may be configured to receive data via the common communication channel and to receive control signals via the at least one control channel.

The receiver may comprise a detector having a frequency band of operation, the frequency band of operation comprising the communication frequency band and the or each control frequency band. The detector may comprise at least one of a photodetector, an antenna, a millimetre wave antenna, a terahertz antenna. A single detector may be used to receive data from the common communication channel and to receive control signals from the at least some control channels.

The first device may comprise a digital filter. The digital filter may be configured to pass signals in the communication frequency band and to filter out signals in the at least one control frequency band.

The first device may further comprise a processor. The digital filter may be configured to pass signals in the communication frequency band to the processor while blocking signals in the at least one control frequency band. The signals in the communication frequency band may be processed by the processor in a way that ignores signals transmitted on other bands.

The receiver of the first device may have a receiver frequency response that decreases with increasing frequency. The or each control frequency band may have a higher frequency than the communication frequency band, such that the communication channel has a higher quality than the at least one control channel.

The characteristics of the detector may be such that the common communication channel is of higher quality than the control channel or channels.

Each further device may comprise a transmitter. The transmitter may be configured to transmit data via the common communication channel and to transmit control signals via one or more control channels.

The transmitter may comprise an emitter having a frequency band of operation, the frequency band of operation comprising the communication frequency band and the control frequency band or bands of the one or more control channels. The detector may comprise at least one of an LED, a laser diode, an antenna, a millimetre wave antenna, a terahertz antenna.

The transmitter of each further device may have a transmitter frequency response that decreases with increasing frequency. The one or more control channels may be of higher frequency than the common communication channel, such that the communication channel has a higher quality than the one or more control channels. The characteristics of the emitter may be such that the common communication channel is of higher quality than the control channel or channels.

The at least one control channel may comprise a plurality of control channels, each control channel corresponding to a respective one of the plurality of further devices.

The at least one control signal may comprise control signals sent by a plurality of the further devices via a corresponding plurality of control channels. For the or each control signal, the first device may be configured to determine which one of the further devices sent the control signal in dependence on the control channel on which the control signal was sent.

The determining of the sending device by the first device in dependence on control channel may allow the control signals to be simple signals, for example single-bit signals. For example, the presence of any signal on a control channel corresponding to a given device may indicate a request to send from that device.

The method may further comprise receiving by the first device an additional control signal from an additional device via an additional control channel, the additional control signal comprising a request to join the wireless network.

The method may further comprise assigning by the first device a control channel to the additional device in response to the request to join the network.

A control channel may be provided on which devices that are not yet part of the network may request to join the network. On receiving a request to join, the first device may allocate a control channel to the joining device. The device may then use the allocated control channel to send control signals, for example to send a request to send.

The at least one control signal may comprise at least RTS.

The method may further comprise sending, on the at least one control channel by at least one of the plurality of devices, control signals comprising at least one of a RTS, a request to join the network, an acknowledgement (ACK), transmission priority information, transmission link information, quality of service information, system requirements information.

The common communication channel may comprise an uplink channel. The common communication channel and a further communication channel may form a full duplex connection between the first device and the plurality of further devices. The further communication channel may comprise a downlink channel.

The first device may be configured to send data to the plurality of further devices via the downlink channel. The first device may be further configured to send control signals to the plurality of further devices via the downlink channel.

The allocating by the first device of the common communication channel may comprise sending control signals to the plurality of further devices via the downlink channel. The control signals may comprise information about the allocation.

The first device may be further configured to send control signals to the plurality of further devices via a plurality of downlink control channels.

The wireless network may comprise an optical wireless network. The common communication channel and/or further communication channel may comprise at least one of visible light, infrared light, ultraviolet light. The or each control channel may comprise at least one of visible light, infrared light, ultraviolet light. The further communication channel may comprise a visible light downlink. The communication channel and plurality of control channels may each comprise an infrared uplink.

The first device may comprise an Access Point and each of the further devices may comprise a Station, optionally a Mobile Station.

The control signals may be modulated, for example frequency shift keying (FSK) modulated.

The method may further comprise sending, by one of the further devices, a timing signal to the first device via an operational channel. The operational channel may be selected to have lower quality than the common communication channel. The timing signal may be obtained from a clock of the one of the further devices.

Providing a timing signal may allow a clock signal from one device to be propagated to another device.

Sending the timing signal in a lower quality channel may allow efficient use of an available bandwidth.

The operational channel may be a dedicated channel. The operation channel may occupy a frequency range that is outside a frequency range occupied by the common communication channel. The operational channel may occupy a frequency range that is not used for data transmission. The operational channel may comprise at least one of visible light, infrared light, ultraviolet light.

The common communication channel may occupy a first part of the transmission or reception band, the at least one control channel may occupy a second, different part of the transmission or reception band and the operational channel may occupy a further, different part of the transmission or reception band. The operational channel may occupy a part of the transmission or reception band that is not used, or is not suitable for use, for data transmission. The operational channel may occupy bandwidth that does not have high enough quality for the transmission of data, but does have high enough quality for the transmission of timing signals.

The operational channel may be, for example, the same channel as the control channel. Thus, the control signal(s) and timing signal(s) may be sent over said same channel. Alternatively, the operational channel and control channel may be different channels. Thus, the control signal(s) and timing signal(s) may be sent over different channels.

The method may further comprising synchronising, by the first device, a clock of the first device with the timing signal.

Providing a timing signal may allow the use of techniques that require the presence of a timing signal, for example techniques that require synchronisation. In some circumstances, the presence of a timing signal may allow clock drift tracking of the first device to be switched off, which may reduce or eliminate jitter or noise. Channel estimation may be made more robust against noise by averaging results over several packets. The synchronisation provided by the timing signal may allow the use of, or improve the performance of, fine amplitude estimation and/or fine timing estimation.

The method may further comprise selecting, by a clock selector of the first device, the timing signal or a clock signal from a clock of the first device.

The use of a clock selector may allow the provision of a clock signal even if the timing signal sent from the one of the further devices becomes too weak to use, or is not present. The clock signal may be obtained internally to the first device if the signal from the one of the further devices cannot be used or is unreliable. If the timing signal is sent in a lower quality region of bandwidth, the use of a clock selector may mitigate against the possibility that the timing channel temporarily has too low a quality to successfully transmit the timing signal.

The timing signal may be unmodulated.

The method may further comprise sending, by the first device, a timing signal to one of the further devices via an operational channel. The operational channel may be selected to have lower quality than the common communication channel. The timing signal may be obtained from a clock of the first device. The method may further comprising synchronising, by the one of the further devices, a clock of the one of the further devices with the timing signal. The method may further comprise selecting, by a clock selector of the one of the further devices, the timing signal or a clock signal from a clock of the one of the further devices.

In a further aspect of the invention, which may be provided independently, there is provided a wireless communication system comprising: a first device; and a plurality of further devices configured to send at least one control signal to the first device via at least one control channel, and to send data to the first device via a common communication channel usable by any one of the further devices. The first device may be configured to allocate the common communication channel to one or more of the further devices, optionally for sending data to the first device, wherein the allocating is in response to the at least one control signal. The sending of the control signal or at least one of the control signals by the at least one of the further devices may be substantially simultaneous with sending of data via the common communication channel, for example by another one of the further devices.

The wireless communication system may be configured to perform a method as claimed or described herein.

In another aspect of the invention, which may be provided independently, there is provided a receiver configured to receive from at least one of a plurality of further devices at least one control signal via at least one control channel. The receiver may be configured to allocate a common communication channel to one or more of the further devices in response to the at least one control signal. The receiving of the control signal or at least one of the control signals by the receiver from the at least one of the further devices may be substantially simultaneous with receiving of data by the receiver via the common communication channel, for example from another one of the further devices.

In a further aspect of the invention, which may be provided independently, there is provided a transmitter configured to send at least one control signal to a first device via at least one control channel to request an allocation of a common communication channel, for example from the first device in response to the at least one control signal, wherein the common communication channel is usable by any one of a plurality of transmitters. The transmitter may be configured to send data to the first device via the common communication channel. The sending of the at least one control signal by the transmitter via the at least one control channel may be substantially simultaneous with sending of data via the common communication channel, for example by another transmitter.

In a further aspect of the invention, which may be provided independently, there is provided a method of communication in an optical wireless network, the optical wireless network comprising: a first device; a second device; a communication channel for sending data from the second device to the first device; and an operational channel for sending operational signals from the second device to the first device. The operational channel may be selected to have lower quality than the communication channel. The method comprises sending by the second device data to the first device via the communication channel and sending by the second device at least one operational signal to the first device via the operational channel. The sending of the at least one operational signal via the operational channel may be substantially simultaneous with the sending of data via the communication channel.

The operational channel may be used to send operational signals efficiently, without affecting transmission on the communication channel. The operational channel may occupy a frequency range outside a frequency range occupied by the communication channel. The frequency range of the operational channel may be higher in frequency than the frequency range of the communication channel. The frequency range of the operational channel may be lower in frequency than the frequency range of the communication channel.

The operational channel may be placed in a frequency band that is not of high enough quality for the transmission of data but is of high enough quality to transmit operational signals. The operational channel may comprise at least one of visible light, infrared light, ultraviolet light.

The at least one operational signal may comprise a timing signal. The timing signal may be obtained from a clock of the second device. The method may further comprise synchronising, by the first device, a clock of the first device with the timing signal.

The method may further comprise selecting, by a clock selector of the first device, the timing signal or a clock signal from a clock of the first device.

The method may further comprise sending control signals by the second device to the first device via a further operational channel. At least one operational signal may comprise at least one control signal. The operational channel and further operational channel may each be selected to have lower quality than the communication channel. Control signals may be sent in a different channel from timing signals.

The at least one operational signal may comprise an interrupt signal.

In a further aspect of the invention, which may be provided independently, there is provided an optical wireless communication system comprising: a first device; and a second device configured to send data to the first device via a communication channel and to send at least one operational signal to the first device via an operational channel. The operational channel may be selected to have lower quality than the communication channel. The sending of the at least one operational signal via the operational channel may be substantially simultaneous with the sending of data via the communication channel.

The optical wireless communication system may be configured to perform a method as claimed or described herein.

In a further aspect of the invention, which may be provided independently, there is provided an optical receiver configured to receive from a second device data via a communication channel and to receive from the second device at least one operational signal via an operational channel. The operational channel may be selected to have lower quality than the communication channel. The sending of the at least one operational signal via the operational channel may be substantially simultaneous with the sending of data via the communication channel.

In a further aspect of the invention, which may be provided independently, there is provided an optical transmitter configured to send data to a first device via a communication channel and to send at least one operational signal to the first device via an operational channel. The operational channel may be selected to have lower quality than the communication channel. The sending of the at least one operational signal via the operational channel may be substantially simultaneous with the sending of data via the communication channel.

There may also be provided an apparatus, method, receiver or transmitter substantially as described herein with reference to the accompanying drawings.

Any feature in one aspect of the invention may be applied to other aspects of the invention, in any appropriate combination. For example, apparatus features may be applied to method features and vice versa.

### DETAILED DESCRIPTION OF EMBODIMENTS

Embodiments of the invention are now described, by way of non-limiting examples, and are illustrated in the following figures, in which:

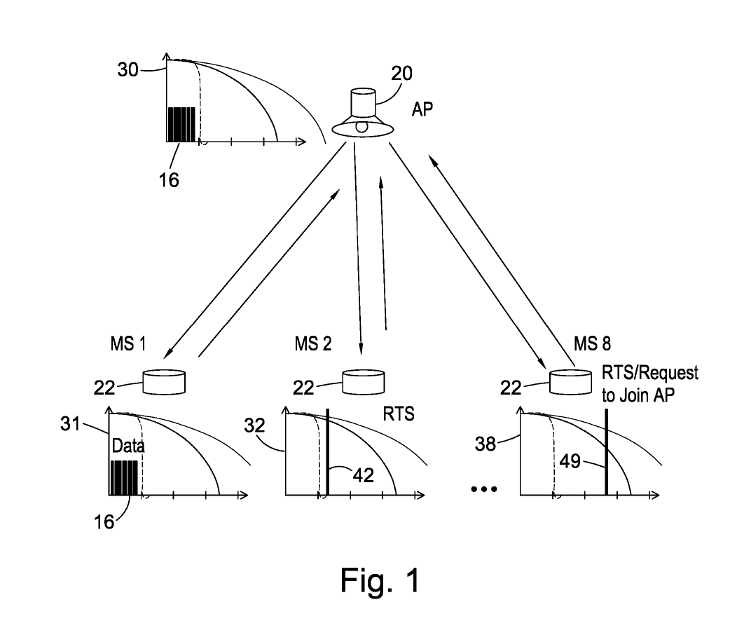

FIG. 1 is a schematic illustration of an optical wireless network according to an embodiment;

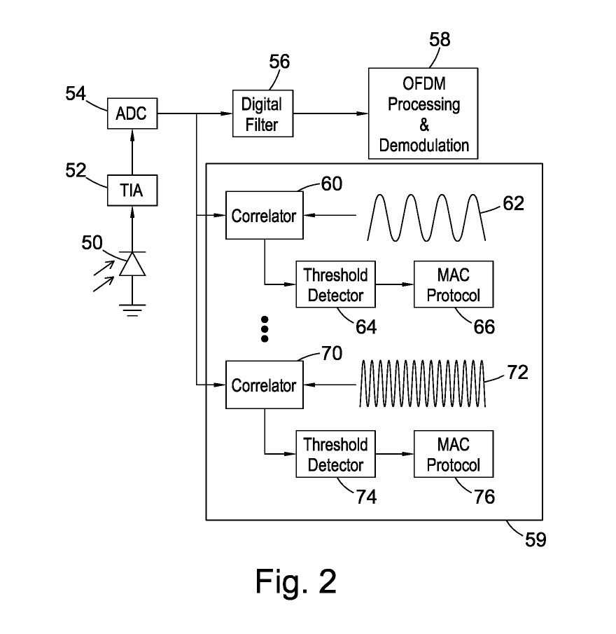

FIG. 2 is a schematic diagram representing a receiver architecture in accordance with an embodiment;

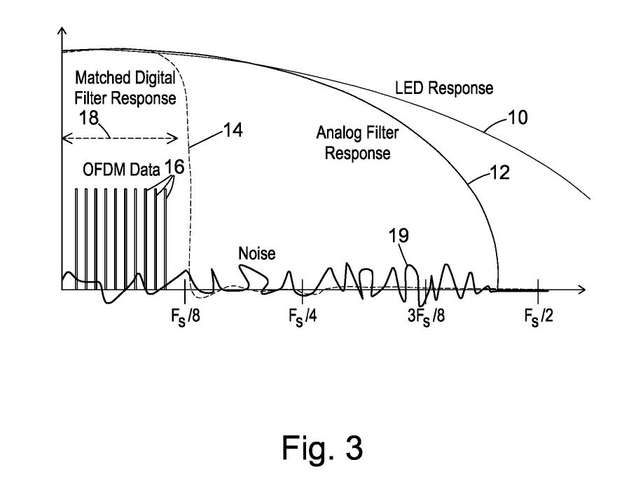

FIG. 3 is a graph representative of a system frequency response;

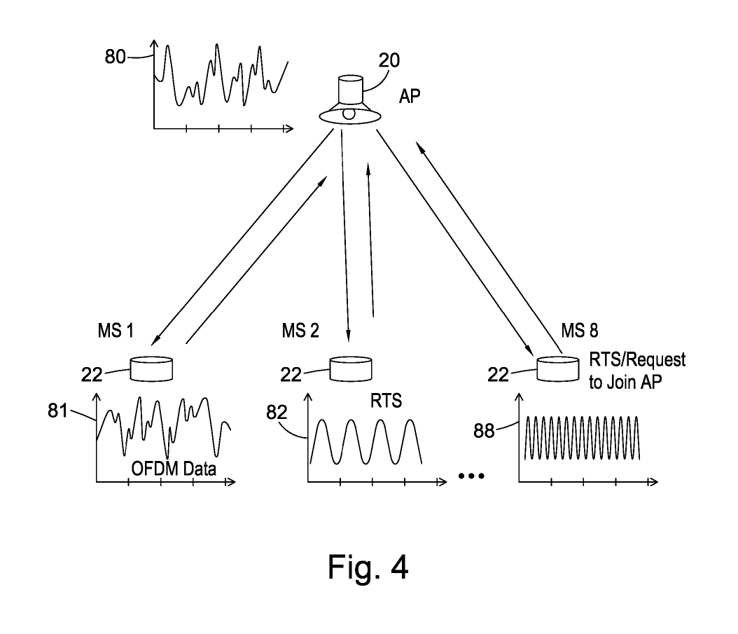

FIG. 4 is a schematic illustration of an optical wireless network according to an embodiment;

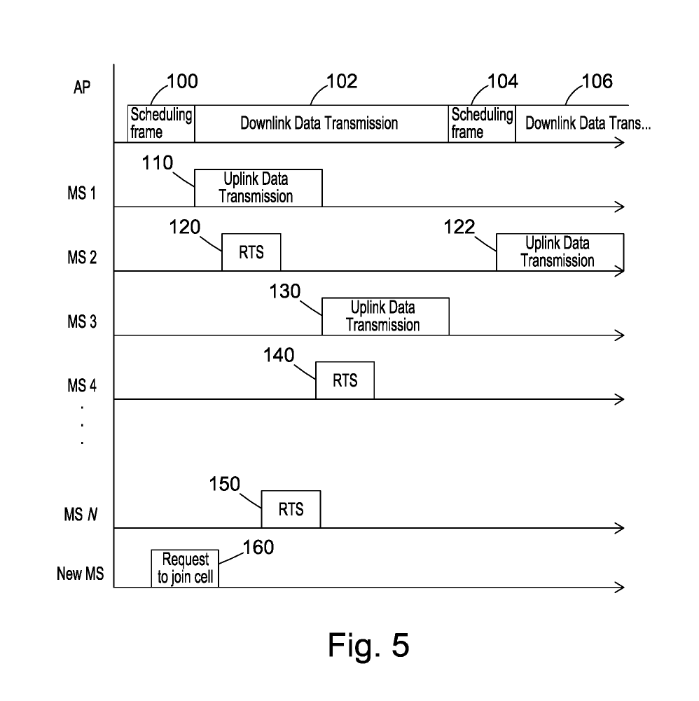

FIG. 5 is a schematic timing diagram representing the timing of transmissions in an optical wireless network in accordance with an embodiment;

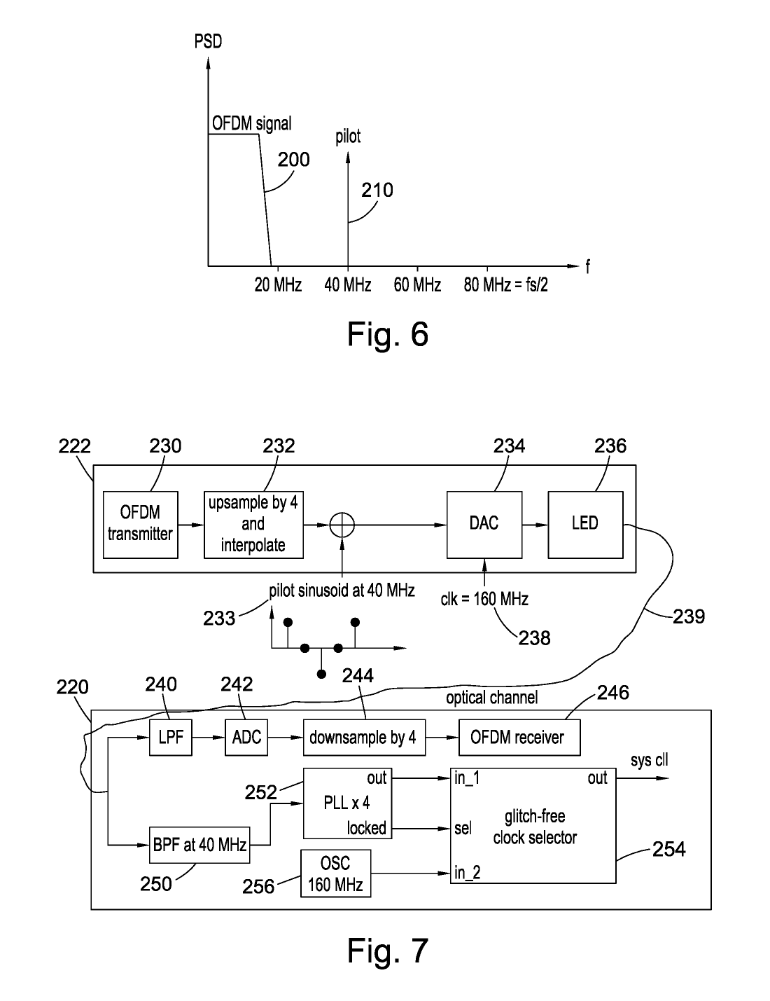

FIG. 6 is a plot showing frequencies of a data signal and timing signal in the frequency domain; and

FIG. 7 is a schematic diagram representing a transmitter and receiver architecture in accordance with an embodiment.

FIG. 1 shows an embodiment of an optical wireless network in which one access point (AP 20) may send data to and receive data from each of a plurality of mobile stations (MSs) 22. The AP 20 is configured to send data to the MSs 20 via a common downlink channel. The MSs 22 are configured to send data to the AP 20 via a common uplink channel which is shared between the MSs 22. The MSs 22 are further configured to send control signals to the AP 20 via a plurality of control channels. Control signals may be sent on the control channels without interrupting the transmission of data on the common uplink channel.

In the scenario illustrated in FIG. 1, seven mobile stations MS1 to MS7 (of which only MS1 and MS2 are illustrated in FIG. 1) are already part of the optical wireless network. Each of MS1 to MS7 is assigned a respective control channel on which to transmit control signals. An eighth control channel is available and is not yet assigned to any MS.

In FIG. 1, MS8 is requesting to join the optical wireless network using a ninth control channel which is assigned to requests to join. When a request to join from MS8 is accepted by the AP 20, MS8 is assigned the eighth control channel for use in sending control signals to the AP 20. Each of the first to ninth control channels lies outside the common uplink channel.

In the embodiment of FIG. 1, seven mobile stations (MS1 to MS7) are initially present in the optical network, and are later joined by an eighth mobile station, MS8. In other embodiments, any suitable number of mobile stations may be present in the optical wireless network or may join the optical wireless network. The optical wireless network may comprise multiple access points, with each AP 20 being optically connected to zero, one or more mobile stations 22. In further embodiments, the stations 22 may not be mobile stations. The stations 22 and AP 20 may each comprise any suitable wireless network device.

In the embodiment of FIG. 1, the access point 20 is connected to a wired data link, for example to an Ethernet link (not shown). The mobile stations 22 may be each be connected to or be part of a computer or other device (not shown). For example, each mobile station 22 may be connected to or form part of a mobile communications device such as a cellphone, laptop computer or tablet computer.

The system of the embodiment of FIG. 1 is a full-duplex system, using separate and independent channels for uplink and for downlink. Any one of the access point 20 or mobile stations 22 may receive and transmit data simultaneously. For example, the access point 20 may receive uplink data that is sent on the common uplink channel while sending downlink data on the common downlink channel. In other embodiments, the system may be a half-duplex system. A single common communication channel may be used for uplink and for downlink.

In the embodiment of FIG. 1, visible light transmission is used for downlink. Infrared transmission is used for uplink. The common uplink channel and control channels each occupy infrared frequencies. In other embodiments, any suitable frequency or frequencies of light (for example, including infrared, visible or ultraviolet light) may be used for the uplink and downlink. For example, any electromagnetic radiation with a wavelength between 10 nm and 2500 nm may be used, with different wavelengths being used for uplink and downlink.

In further embodiments, RF radiation may be used for uplink and/or downlink. The uplink channels may comprise RF channels, for example millimetre wave or terahertz channels. The radiation used for uplink and/or downlink may comprise, for example, RF radiation with a frequency between 30 and 300 GHz, or RF radiation with a frequency between 300 GHz and 3 THz. In cases in which the channels comprise RF channels, light sources and light detectors described below may be replaced with suitable antennas.

The system of FIG. 1 may be used for local communications. A wireless transceiver device (for example, the AP 20 or one of the MSs 22) may have a transmission cone with a half-angle less than 90 degrees and/or a receiver field-of-view of less than 180 degrees. An AP 20 may communicate with MSs that are in a limited area in the transmission cone of the AP. An MS may communicate with an AP that is within its limited field of view. Therefore the coverage of the network may be highly localised. The localised nature may allow different networks or parts of a network (for example, different APs) to use the same or similar channels.

Turning to the access point 20 itself, the access point 20 comprises a transmitter comprising a visible light source. The visible light source may be used to send data on the common downlink channel by modulation of visible light. In the present embodiment, the light source is an LED lamp. In other embodiments, the light source may be any appropriate coherent or incoherent light source, for example a laser light source.

The access point 20 further comprises a receiver comprising a light detector. FIG. 2 is a schematic diagram of the receiver architecture of the AP 20. The receiver comprises a light detector (photodiode 50), a transimpedance amplifier (TIA) 52, an analog filter (not shown), an analog to digital converter (ADC) 54, a digital filter 56, an OFDM processing and demodulation component 58, and correlation circuitry 59. The correlation circuitry 59 comprises a plurality of correlation units, each correlation unit comprising a correlator 60, 70, a signal generator 62, 72, a threshold detector 64, 74 and a MAC protocol component 66, 76. The receiver is configured to receive and process data sent on the common uplink channel and to sense control signals sent on the control channels.

Each of the mobile stations 22 comprises a transmitter comprising a light source and a receiver comprising a light detector. The receiver architecture of an MS 22 may be the same or similar to the receiver architecture of the AP 20 described above with reference to FIG. 2. The components of the mobile station 22 may operate at different frequencies to those of the AP 20. For example, in the present embodiment, the receiver of the AP 20 is configured to receive infrared light and the receiver of each MS 22 is configured to receive visible light.

The frequency response of a transmitter front-end of a wireless communication device (for example, the AP 20 or a mobile station 22) may be limited by a frequency response of the light-emitting diode. In FIG. 1, plot 30 is representative of a system frequency response of the system of FIG. 1. An enlarged and annotated version of plot 30 is presented as FIG. 3.

Plots 31, 32 and 38 of FIG. 1 are representative of transmissions by MS1, MS2 and MS8 respectively. Plots 31, 32 and 38 of FIG. 1 may have similar axes, LED frequency response curves, analog filter frequency response curves and digital filter frequency response curves to those of plot 30 and FIG. 3 as described below.

FIG. 3 plots system frequency response of the present embodiment of the optical wireless system against frequency, where Fₛ is a sampling rate (Nyquist rate). In this example, the vertical axis of FIG. 3 plots Gain in [dB] where the highest value (in this example, the DC or f=0 component) is normalised to Gain=1, or Gain=0 dB. In general, system frequency response may be measured in terms of any relevant output quantity that varies with frequency.

FIG. 3 may be considered to be a visualization of common resources in a baseband wireless system. The common resources in this case may be the common uplink channel that is shared by the MSs 22. Although FIG. 3 is described below with reference to transmission by the MSs 22 and reception by the AP 20, in some circumstances similar frequency response characteristics may apply to transmission by the AP 20 and reception by the MSs 22 (although in some cases frequencies may be different).

Each of the electronic components in the transmitter of an MS (or AP) and in the receiver of the AP (or MS) may have a response that varies with frequency. The components with the worst response may become a limiting factor in the system. For the transmitter, the limiting factor may be the LED frequency response (denoted by 10 in FIG. 3). The LED frequency response may be the limiting response for the overall communication system.

Noise in the system of FIG. 1 is represented by line 19 of FIG. 3. Noise is assumed to have fairly constant power in frequency, but may roll-off with the analog filter.

In the example of FIG. 3, the frequency response of the light-emitting diode (LED) of a mobile station 22 (for example, MS1) varies with frequency as shown by line 10. The frequency response of the LED may be power output against frequency. The frequency response of the light-emitting diode is fairly flat for a first, lower-frequency portion and then rolls off gradually with frequency.

In use, transmitted light from the light-emitting diode of the mobile station 22 is received by the photodetector 50 of AP 20. The received signal is filtered by the analog filter and then by the digital filter 56. The frequency response of the analog filter is shown as line 12 of FIG. 3. The frequency response of the analog filter may be the signal output from the analog filter in comparison to the signal input to the analog filter, as a function of frequency. For example, at a low frequency the analog filter may deliver a high proportion of the signal that is input to the analog filter. At a higher frequency, the analog filter may deliver a smaller proportion of the signal that is input to the analog filter. The AP receiver frequency response may be limited by the frequency response of the analog filter. The analog filter is a low pass filter which is configured to remove excess noise from the system. The role of the analog filter when no emission in higher frequency bands is present may be to remove any noise that is outside the sampling rate of the ADC 54 and hence cannot be removed with the digital filter later on.

The frequency response of the digital filter 56 is represented by line 14 of FIG. 3. The frequency response of the digital filter 56 may be the signal output of the digital filter in comparison to the signal input to the digital filter, as a function of frequency. A communication bandwidth for use in transmission of data may be defined by the frequency response 14 of the digital filter 56. The digital filter 56 may limit the bandwidth that is available for use in transmission of data. The digital filter 56 may accurately shape a transmission frequency profile within a desired band and may remove excess noise that the analog feature cannot completely reject.

In the present embodiment, the common uplink channel 18 occupies part of the communication bandwidth that is defined by the digital filter response 14. The MSs 22 are each configured to send OFDM (orthogonal frequency division multiplexing) data 16 to the AP 20 over the common uplink channel 18. Plot 31 of FIG. 1 represents the sending of OFDM data 16 over the common uplink channel 18 by MS1. Plot 30 of FIG. 1 represents the receiving of the OFDM data 16 over the common uplink channel by the AP 20.

The common uplink channel 18 is a channel over with OFDM signals are sent. The bandwidth of the common uplink channel 18 may be referred to as the OFDM signal bandwidth. In an ideal system, the digital filter bandwidth may be the same as the OFDM signal bandwidth. However, in practice, the bandwidth of the digital filter may be slightly wider than the OFDM signal bandwidth. We note that FIG. 3 is illustrative and may not show bandwidths to scale.

The OFDM data 16 is sent over a plurality of OFDM subcarriers which are represented as sharp peaks in the illustration of OFDM data 16. What is depicted in FIG. 3 is the peak of the subcarrier bands. In practice, the bandwidth of the OFDM subcarriers may not be as sharp as is shown in FIG. 3.

In embodiments, the common uplink channel 18 may occupy a part of the communication bandwidth defined by the digital filter 56, or all of the communication bandwidth defined by the digital filter 56.

The system of FIG. 1 is a baseband system in which the communication is limited by the frequency response and the noise in front-end devices.

In FIG. 3, the frequency response curve 10 of the LED is fairly flat across the communication bandwidth. The frequency responses of the analog filter and digital filter are also fairly flat across the communication bandwidth. However, in further embodiments, the communication bandwidth may be extended into a region in which a frequency response of the system (for example, the frequency response curve of the LED) begins to roll off. A station may not have to communicate only within a flat portion of the system bandwidth. In some embodiment, a frequency response of the system varies across the communication bandwidth.

In FIG. 3, the sampling rate Fₛ is approximately four times higher than a minimum sampling rate that is required for transmission of the presented OFDM data 16. The higher sampling rate may enable the implementation of the digital filter and enable removal of excess noise energy in higher frequency. According to the Nyquist sampling theorem, frequencies up to Fₛ/2 may be uniquely represented in the digital signal domain and hence processed using digital signal processing techniques such as digital filtering.

The communication bandwidth defined by the digital filter response 14 may be considered to be a limited resource. If a higher communication bandwidth were used in the system, for example a communication bandwidth wider than that shown in FIG. 3, more noise may be accumulated. The additional noise, in combination with the decaying frequency response of the analog transmitter front-end, may lead to a reduction in the available signal-to-noise ratio. The noise and the transmitter front-end frequency response may limit the maximum bandwidth that can be used for successful data communication.

In addition to sending OFDM data 16 to the AP 20 over the common uplink channel 18, each mobile station 22 is further configured to send control signals (for example, RTS signals) to the AP 20 on a respective control channel. For example, MS1 is configured to send control signals to the AP 20 on a first control channel, and MS2 is configured to send control signals to the AP 20 on a second control channel.

Examples of control channel carriers are indicated on plots 32 and 38 respectively. Control channel 42 is the second control channel in the network and is assigned to MS2. Control channel 49 is the ninth control channel in the network and is assigned to requests to join the network.

Individual narrow bandwidth control channels are assigned to the MSs, and each control channel is centred on or around a different carrier frequency. Each of the first to ninth control channels occupies a frequency carrier that is outside the communication bandwidth defined by the digital filter response 14. The control channels therefore have lower quality (in this case, lower signal to noise ratio) that the common uplink channel 18. The common uplink channel 18 occupies the communication bandwidth, which is the part of the system bandwidth with the highest signal to noise ratio. The control channels (for example, 42 and 49) are in a part of the system bandwidth with lower signal to noise ratio. The capacity for information transfer varies across the frequency band of operation of the AP 20 and of the MSs 22. The common uplink channel 18 occupies a part of the frequency band having higher capacity for information transfer, and each of the control channels occupies a part of the frequency band having lower capacity for information transfer than the part of the frequency band that is occupied by the common uplink channel 18.

The control channels do not interfere with the communication of data 16. The control channels are filtered out by the digital filter at the receiver of the AP, as is further described below with reference to FIG. 2.

The bandwidth of the control channels may depend on how quickly the channels are modulated (for example, how quickly the control channels are turned on and off, in a simple implementation). For example, if the time intervals at which they are turned on and off is the same as one OFDM frame duration, then the bandwidth of the control channels may be the bandwidth of a single OFDM subcarrier. If the time intervals at which the control channels are turned on and off is two times faster than an OFDM frame duration, then the bandwidth of a control channel may be the bandwidth of two OFDM subcarriers, etc. The bandwidth of the OFDM subcarriers depends on what is the sampling rate of the signal samples transmitted in the time domain. In the example depicted in FIG. 3, the bandwidth of each of the OFDM subcarriers may be Fₛ/8/number_of_OFDM_subcarriers.

A difference in SNR between the common uplink channel occupying a given frequency band and a control channel occupying a different frequency band may be proportional to the square of the ratio of the frequency response of the LED at the two frequency bands. In the present embodiment, the LED is the limiting element. In other embodiments, the difference in SNR between a first channel and a second channel may be proportional to the square of the ratio of whichever is the limiting element in the system at the frequency band of the first channel and the frequency band for the second channel.

Usable SNR and usable channel quality may depend on the data modulation technique used or the way the data is encoded. The rate of communication may be a rate at which data is transmitted on the channel, e.g. a rate at which a signal on the channel is turned on and off. If the rate of communication on a channel is decreased, the bandwidth may be decreased and hence the noise may be decreased. The same amount of signal energy may be distributed over a smaller bandwidth, which may contain less noise.

In the present embodiment, each mobile station has a corresponding individual control channel. In other embodiments, a control channel may be shared between two or more MSs. In further embodiments, more than one control channel may be assigned to each MS.

In the scenario illustrated in FIG. 1, mobile station MS1 sends OFDM data 16 to AP 20 via the common uplink channel 18 as illustrated in plot 31.

Each mobile station MS1 to MS7 has an assigned control channel on which to send control signals. Mobile station MS2 sends a control signal to AP 20 using the second control channel 42 as illustrated in plot 32. In the present example, the control signal sent from MS2 to AP 20 is an RTS.

Mobile station MS2 sends the RTS to AP 20 using control channel 42 while MS1 is sending OFDM data 16 to AP 20 using the common uplink channel 18. There is therefore simultaneous transmission of an RTS on control channel 42 and data on the common uplink channel 18. Since the RTS is sent on control channel 42 while the OFDM data 16 is sent on common uplink channel 18, and since the control channel 42 is outside the common uplink channel 18, the sending of the RTS by MS2 does not interrupt the sending of the OFDM data 16 by MS1.

In response to the RTS from MS2, the AP 20 allocates a transmission slot on the common uplink channel to MS2.

Mobile station MS8 sends a control signal to AP 20 via the ninth control channel 49 as illustrated in plot 38. The ninth control channel 49 occupies a different frequency carrier from the second control channel 42. In this example, the control signal sent by MS8 is a request to join the AP.

In response to the request to join from MS8, the AP assigns an RTS channel (the eighth control channel) to MS8.

MS1 is transmitting over the common uplink channel while at the same time MS2 and MS8 are sending an RTS and a request to join the AP respectively. MS2 is sending an RTS signal while MS8 is using the ninth control channel to make its presence known to the AP 20. The RTS and request to join are sent in parallel using frequency carriers that are outside the communication bandwidth. There is therefore simultaneous transmission of more than one control signal on different control channels. Since each control signal uses a different control channel 42, 49, and each control channel is outside the common uplink channel 18, the sending of each control signal does not interrupt the sending of the OFDM data 16, and the sending of a control signal by one MS does not interrupt the sending of a control signal by another MS.

The AP 20 may successfully demodulate the data transmitted by MS1 while at the same time, in parallel, sensing the RTS request by MS2 and sensing the presence of a new station (MS8) in the cell. Hence, the AP 20 can schedule a transmission slot for MS2 and assign an RTS channel to MS8. Details of the method by which the AP 20 senses the control signals are described below with reference to FIG. 2.

FIG. 4 is a schematic diagram showing the system that is shown in FIG. 1 from the time-domain point of view. Plots 80, 81, 82 and 88 correspond to plots 30, 31, 32 and 38 respectively of FIG. 1. Each of plots 80, 81, 82 and 88 is a plot of amplitude versus time. MS1 sends, and AP 20 receives, modulated OFDM data as illustrated in plots 80 and 81. Each of MS2 and MS8 sends a single frequency signal as illustrated in plots 82 and 88.

By assigning an individual control channel to each mobile station, control signals from different mobile stations may be sent in parallel with each other on different control channels. Since the control channels are outside the common uplink channel, control signals from one or more mobile stations may be sent on one or more control channels in parallel with the transmission of data by a further mobile station on the common uplink channel 18.

At any point in time, an MS 22 that is already connected to the AP 20 and that has been assigned a control channel can send an RTS request to the AP 20 via its assigned control channel without interrupting an uplink data transmission from a different MS 22. The MS 22 may send the RTS on one of the control channels while the different MS 22 sends data using the common uplink channel.

It is possible for several MSs 22 to send RTS requests to the AP 20 simultaneously or sequentially. In the present embodiment, the AP 20 is configured to allocate a respective transmission slot on the uplink control channel to each MS 22 that sends a RTS.

The AP is configured to send scheduling control signals to the MSs in response to RTSs from the MSs. In the present embodiment, the scheduling control signals are sent from the AP to the MSs on the same downlink communication channel on which data is sent from the AP to the MSs. The scheduling control signals are sent in a special scheduling frame. All MSs may be made aware of a new transmission configuration via the scheduling frame incorporated in the downlink transmission. In other embodiments, the scheduling control signals are sent from the AP to the MSs on specially allocated subcarriers for the downlink control signalling.

The approach of the present embodiment may effectively manage communication resource contention in a baseband system. Baseband wireless systems may include, but are not limited to, OWC systems, VLC systems and Li-Fi systems (where Li-Fi systems comprise systems for high speed optical network wireless communications). In a baseband system the communication bandwidth may be limited by the frequency response and/or noise in the front-end devices (for example, in an LED, laser diode or photodetector in a VLC system). Bandwidth may be limited by properties of front-end components rather than by spectrum allocation.

Resource contention may be effectively managed by enabling the AP 20 to constantly monitor the transmission resources of the different MSs 22. The AP 20 may implement efficient scheduling routines such as adaptive TDMA. The resources, for example the use of the common uplink channel, may be allocated only to MSs 22 that need to use them.

The AP may be constantly aware of the data transmission requirements of the MSs. A network AP may be fully aware of the connectivity requirement of all MSs within its intended coverage without the need to interrupt uplink or downlink transmission to inspect the state of each device in the network. The AP's awareness may allow the use of very efficient scheduling algorithms for both downlink and uplink transmission. The AP's awareness may allow predictions for the downlink transmission.

A transmitting station may occupy the bandwidth where data is located, which in this embodiment is the common uplink channel. Communication outside the frequency band of the transmitted data may be used by the MSs for communication or for signalling important information to the AP, such as RTSs and requests to join the AP in an optical attocell.

Control signals may be transmitted on frequency bands that are of poorer quality (for example, having a lower signal to noise) than frequency bands that are used to transmit data. The method of FIG. 1 may not trade off spectral efficiency. The method of FIG. 1 may not require additional bandwidth that is not available to the user. In some OWC or VLC systems, the communication bandwidth of a system may be constrained by physical properties of the front-end devices rather than by regulations. Therefore, bandwidth above the communication bandwidth may be available for use, but not used in some previous system. The method of FIG. 1 may take advantage of bandwidth that is available by spectrum allocation but that was not utilized in previous systems.

The communication bandwidth of some RF systems may be constrained by regulations. However, the bandwidth of some other RF systems may not be constrained by regulations. For example, some millimetre wave or terahertz systems may be constrained by physical properties of their front-end devices rather than by spectrum allocation. Some RF systems may implement the method of FIG. 1 by sending data on a common communication channel in a high-quality part of the system bandwidth of the RF system, and sending control signals on separate control channels in a lower-quality part of the system bandwidth.

The bandwidth resources provided by the method of FIG. 1 may be used to implement an efficient MAC protocol. The use of the bandwidth resources may improve the overall system throughput compared with some existing systems.

By providing control signals on separate control channels, it may be possible to avoid collisions in the system. It may be the case that substantially no collisions occur when using the method of FIG. 1.

In the method of FIG. 1, substantially no overhead in the uplink channel may be required for polling the MSs and/or for control signalling. The system of FIG. 1 may allow data transmission overhead due to the MAC protocol to be kept at a minimum.

The system of FIG. 1 may enable multiple mobile stations to communicate in parallel important control signalling information such as, but not limited to, requests to send (RTSs) and requests to connect to an access point (AP). Control signalling information may be sent without the need to interrupt the data transmission of an established link.

Returning to FIG. 2, the AP receiver is configured to sense transmissions on control channels 41 to 49 while receiving and decoding data on common uplink channel 18. The processes of sensing and decoding are now described. The sensing of the control channels may be substantially simultaneous with the decoding of data from the common uplink channel.

Since the sampling frequency of the receiver system is higher than the Nyquist rate of the received data and of the control channels, the received digital signal may be used both for data recovery (after digital filtering) and for carrier sensing to detect the presence of an RTS or the presence of a request to join the network on the control channel carriers.

In the present embodiment, carrier sensing and control signal information recovery is implemented in the digital domain. In other embodiments, the carrier sensing and control signal information recovery may be implemented in the analog domain.

The light detector (photodiode 50) of the AP receiver receives modulated light and converts the received light to a current signal. The transimpedance amplifier (TIA) 52 converts the current signal to a voltage signal. The voltage signal from the TIA 52 is filtered by the analog filter (not shown). The filtered voltage signal from the analog filter is digitized by an analog-to-digital converter (ADC) 54. One copy of the resulting signal from the ADC 54 is supplied to a digital filter 56. Additional copies of the resulting signal from the ADC 54 are supplied in parallel to carrier sensing circuitry 59 comprising correlators 60, 70.

The digital filter 56 is used to filter the digitized signal. The digital filter 56 removes any higher frequency components (for example, frequencies above the communication channel) and excess noise from the signal it receives from the ADC 54. It then supplies its output (a filtered signal) to demodulation circuitry comprising an OFDM processor and demodulator 58. In the present embodiment, the OFDM processor and demodulator 58 is a single component. In other embodiments, the OFDM processor and demodulator may comprise more than one component. Demodulation circuitry may comprise further components that are not shown. The demodulated signal may be passed to higher layers of the AP, for example to a MAC layer.

The control channels may not interfere with the data communication as the control channels may be substantially filtered out by the digital filter 56.

In some embodiments, a data processing algorithm in the AP may be the same as a data processing algorithm in an AP in which no separate control channels are used, for example an AP in which signals are received only on the common uplink channel and other parts of the bandwidth are not used. The digital filter may substantially eliminate any effects of the higher frequency control channels.

In parallel to the digital filtering, processing and demodulation of one copy of the digital signal, the carrier sensing circuitry 59 receives further copies of the digital signal from the ADC 54 and attempts to detect the presence of a signal on each of the control channels. Each of the control channels has a different carrier. Each carrier has a different frequency. The carrier sensing circuitry 59 attempts to detect the presence of a signal on each of the control channels by correlating the expected waveform for each control channel with the received signal.

For example, the output of the ADC 54 is passed to correlator 60. Correlator 60 also receives a generated waveform from a signal generator 62. The generated waveform has the same frequency as a first control signal carrier. In this example, the first control signal carrier is the carrier for control channel 42.

The correlator 60 correlates the output of the ADC 54 with the generated waveform from the signal generator 62 and outputs a correlation coefficient. The correlation coefficient is passed to a threshold detector 64 which applies a pre-determined threshold to the correlation coefficient. The presence of a signal on the first control signal carrier is indicated by a correlation coefficient that is higher than the pre-determined threshold. In the present embodiment, the presence of a signal on the first control signal carrier indicates an RTS from MS2. If the correlator returns a correlation coefficient that is greater than the pre-determined threshold, the carrier sensing circuitry determines that an RTS has been sent from MS2.

The output of the ADC 54 is also passed to further correlators, one for each control signal carrier. For example, the output of the ADC 54 is passed to correlator 70. Correlator 70 receives a generated waveform from signal generator 72 that has the same frequency as a second control signal carrier. In this example, the second control signal carrier is the carrier for control channel 49 and has a higher frequency than the first control signal carrier for control channel 42. The correlator 70 correlates the output of the ADC 54 with the generator waveform from signal generator 72 and outputs a correlation coefficient. The correlation coefficient is passed to a threshold detector 74 which applies a pre-determined threshold to the correlation coefficient. The presence of a signal on the second control signal carrier is indicated by a correlation coefficient that is higher than the pre-determined threshold. In the present embodiment, the presence of a signal on the second control signal carrier indicates the presence of a new MS (MS8) that wishes to join the AP. If the correlation coefficient returned by the correlator 70 is greater than the pre-determined threshold, the carrier sensing circuitry determines that a new MS is requesting to join the AP.

In the present embodiment, the phase of the control channel carriers is not estimated. Therefore, a second correlation with a 90°-phased version of the correlation sequence (for example, a 90°-phased version of the waveform from signal generator 62) is introduced. The correlator (for example, correlator 60) correlates the output of the ADC 54 to the original version of the correlation sequence (the generated waveform from signal generator 62) and to the 90°-phased version. The output of both correlation operations is used in the threshold detector 64.

The output of both correlation operations comprises a correlation coefficient for the original version and a correlation coefficient for the 90°-phased version. The threshold detector determines that a signal is present on the control signal carrier in question if the correlation coefficient from the original version of the waveform and/or the correlation coefficient from the 90°-phased version is above the pre-determined threshold. The use of the 90°-phased version in addition to the original version may account for any phase shift of the control channel carriers.

In other embodiments, a single version of the correlation sequence (and not a 90°-phased version) is used. In some embodiments, phase is taken into account. In further embodiments, carrier sensing may be implemented using alternative techniques, such as (but not limited to) filtering and/or fast Fourier transform (FFT). A detection algorithm may differ from that of the present embodiment.

In the present embodiment, the presence of a signal above a threshold level on the first control channel carrier (as indicated by a correlation coefficient above a pre-determined threshold) is indicative of a request to send on the first control channel. The presence of a signal above a threshold level on the second control channel carrier is indicative of a request to join the network on the second control channel. The signal on each control channel may comprise a single bit and each correlator may determine whether a signal is present or not.

In other embodiments, the control carrier may be modulated with data that is encoded in the amplitude or the phase of the carrier. In such embodiments, it may be possible to convey commands that are more complex than an RTS or a request to join. In some embodiments, a sequence of control values at different carriers may be conveyed in a sequential manner. The amplitude and/or phase of a carrier may change in order to convey an intended control value. The amplitude and/or phase of a control channel carrier may be modulated in time to convey more information sequentially in time.

In some embodiments, an MS is assigned multiple carriers. In some embodiments, an MS is assigned multiple carriers, and different control signals are assigned to different carriers. The MS may send a particular control signal by transmitting on a particular carrier. In some embodiment, an MS may use multiple carriers for faster transmission of different control signals. An MS may be allocated more than one carrier. Each carrier may only be valid for certain commands. Other carriers may be used for other commands.

In some embodiments, a set of control subcarriers are assigned for use by all the MSs and individual control signals are separated using an orthogonal multiple access method such as CDMA. In such embodiments, a more sophisticated transmission and/or detection algorithm may be used.

In some embodiments, complex control signalling requests may be made which may include but are not limited to: transmission priority information, transmission link information, quality of service information, systems requirement information.

In some circumstances, a large amount of additional, previously unused, spectrum may be available outside the communication bandwidth. The additional spectrum may be used for transmission of control signals outside the data band. In some embodiments, all or almost all control channel signalling may be performed outside the data band.

In the embodiment of FIG. 1 with up to 8 MSs per AP, 8 subcarriers are assigned for transmission of RTSs by 8 MSs. One subcarrier is assigned to each MS. Each subcarrier that is assigned to an MS is used solely for RTS signals. A ninth subcarrier is assigned for signalling the presence of a new MS in the attocell covered by the AP. A new MS may negotiate its connection to the AP on a contention-based principle. New MSs may use the same (ninth) channel for requesting to join the AP. If more than one MS wants to signal a request to join (using the same channel), then a contention-based algorithm may have to be employed to allow new MSs to negotiate their connection to the AP.

In other embodiments, more than one subcarrier is assigned per MS. For each MS, one subcarrier may be used for RTS signals and another subcarrier (or other subcarriers) may convey other control information such as data reception acknowledgements (ACKs).

In some embodiments, an MS has a control channel available for sending of acknowledgements. In such embodiments, the MS may be able to send acknowledgements without having to have the uplink channel at its disposal. In contrast, in some examples in which the MS does not have a control channel available for sending of acknowledgements, the MS must request the uplink channel in order to be able to send acknowledgements.

In the embodiment of FIG. 1, a part of the system bandwidth that is outside the frequency band of the transmitted data 16 is used for transmitting control signals on a plurality of control channels, for example one control channel for each mobile station 22. In the present embodiment, the part of the bandwidth used for the control channels has higher frequency than the part of the bandwidth used for the common uplink channel 18.

In other embodiments, any bandwidth outside the frequency band of the transmitted data 16 may be used by the MSs for communication or for signalling information such as RTS or requests to join. For example, frequencies lower than the data transmission bandwidth may be used for control signalling. The bandwidth used for each control channel may be at a lower frequency than the common uplink channel 18.

In some embodiments, the control channels may have better quality than the common uplink channel 18. In some embodiments, the control channels are allocated at frequencies lower than the frequency at which the data is transmitted on the common uplink channel 18. Allocating lower-frequency control channels having better quality may allow for better quality of the control signalling. Depending on the frequency response of the devices, allocating lower-frequency control channels may not lead to a significant sacrifice of data rate in some embodiments.

FIG. 5 is a timing diagram illustrating the transmitting of data and of control signals in a TDMA embodiment of an uplink multiple access scheme. An optical wireless network includes an access point AP 20 and a plurality of MSs 22. In this embodiment the number of MSs is N and the MSs are numbered MS1, MS2, MS3, MS4 . . . MSN.

The AP 20 is configured to receive requests for transmission slots (RTSs) from the MSs 22 over respective control channels of the MSs 22, and to allocate transmission slots to all MSs 22 that have requested a transmission slot. When an MS 22 is allocated a transmission slot, the MS 22 may transmit uplink data over the communication during that transmission slot.

FIG. 5 schematically represents signals sent between the AP 20 and MSs 22. Each device 20, 22 is represented by a respective horizontal line on FIG. 5. Time is represented by the horizontal axis of FIG. 5 and runs from left to right.

The AP 20 transmits a first scheduling frame 100 to the MSs 22 over a downlink channel. In the present embodiment, a scheduling frame is a packet on the downlink which carries relevant information for TDMA slot allocations and transmission synchronizations in the uplink. In other embodiment, any appropriate scheduling frame may be used.

The first scheduling frame 100 allocates transmission slots to MS1 and to MS3, in that order. MS1 and MS3 have previously requested transmission slots but their requests were before the time period illustrated in FIG. 5.

After the transmission of the first scheduling frame 100 on the downlink channel, the AP 20 sends a first downlink data transmission 102 on the downlink channel. While the first downlink data transmission 102 is being sent on the downlink channel, MS1 and then MS3 send uplink data transmissions 110, 130 in their allocated transmission slots. The uplink data transmissions 110, 130 are send over a common uplink channel.

The common uplink channel is shared by the MSs 22. Each MS 22 is also assigned a parallel-frequency control channel. Each parallel-frequency control channel has a different carrier frequency.

While the AP 20 is sending the first data transmission 102 on the downlink channel, and MS1 and MS3 are sending uplink data transmissions 110, 130 on the uplink data communication channel, each of the other MSs 22 in the network is able to request a transmission slot using the parallel-frequency control channel assigned to it for transmitting a RTS. An MS 22 (for example, MS2) may request a transmission slot without interrupting the uplink or downlink data transfer (for example, without interrupting downlink data transmission 102 and/or uplink data transmission 110).

In the present embodiment, MS2 sends an RTS 120 to the AP 20 using its control channel while the AP is sending the first data transmission 102 on the downlink channel, and MS1 is sending uplink data transmissions 110 on the common uplink channel. In the present embodiment, MSN sends an RTS 150 while the AP 20 is sending the first data transmission 102 on the downlink channel, and MS1 is sending an uplink data transmission 110 on the common uplink channel. MS4 sends an RTS 140 while the AP 20 is sending the first data transmission 102 on the downlink channel, and while MS3 is sending an uplink data transmission 130 on the uplink data communication channel.

In the present embodiment, each RTS sent by an MS 22 is a single bit denoting the MS's intent to use the uplink channel. In other embodiments, the RTS may be a sequence of bits. The RTS may provide more information regarding the specific uplink transmission request.

The AP 20 takes note of the RTSs 120, 140, 150. The AP assigns transmission slots to MS2, MS4 and MSN in response to the RTSs 120, 140, 150 sent by MS2, MS4 and MSN.

After the first downlink data transmission 102 is complete, the AP 20 sends a second scheduling frame 104 on the downlink channel. The second scheduling frame 104 includes an allocation of transmission slots to MS2, MS4 and MSN (which are the MSs that sent RTSs during the first downlink data transmission 102). The first data transmission slot to occur after the scheduling frame is assigned to MS2.

After the second scheduling frame 104, the AP sends a second downlink data transmission 106 on the downlink channel. MS2 sends an uplink data transmission 122 to the AP 20 using the common uplink channel. The other transmission slots allocated by the AP 20 in the second scheduling frame 104 are not depicted in FIG. 5 due to space constraints in the figure. The transmission slots allocated to MS4 and MSN follow the uplink data transmission 122 by MS2 and use the common uplink channel.

Any MS 22 that would like to join the cell covered by the AP 20 can request a parallel-frequency control channel to be assigned to it. It can make that request using a special parallel-frequency control channel that is allocated for all new MSs that would like to notify the AP 20 of their presence and request to join the cell. In the present embodiment, MSN is not associated with the AP 20 at the start of the time period illustrated in FIG. 5. MSN sends a request 160 to join the cell using the special control channel that is allocated to requests to join. In the present embodiment, the request to join is a single bit signalling the presence of a new MS 22. In other embodiments, the request to join may be a sequence of bits describing in more detail the specifics of the requested connection.

The provided request to join the cell may or may not be synchronized with the transmission of the other MSs. In some implementations, requests by the different MSs may be synchronized. Synchronization of requests may improve the ability to distinguish the individual signals. An example of synchronization may be that all MSs are allowed to send requests only on given time intervals after the reception of a scheduling frame. In some embodiments, synchronization may be applied even if only one control channel is allocated to a single mobile station.

The scheme presented above, for example in FIG. 5, may be combined with a polling mechanism to allow any MSs that would like to use the common uplink channel to provide the AP 20 with additional information relevant for the transmission.

FIG. 5 is a simple schematic timing diagram. A more detailed timing diagram may include guard intervals between the transmission slots. Guard intervals may be used between the transmission slots in order to facilitate a more reliable multiple access scheme.

In some embodiments, a contention-based algorithm may be introduced to allow multiple new MSs that would like to join the cell to negotiate their addition to the multiple access scheme.

In the embodiments described above with reference to FIGS. 1 to 5, a common communication channel (which in those embodiments is a common uplink channel 18) is used to transmit data from a plurality of MSs 22 to an AP 20. Bandwidth in a higher frequency range than the common communication channel is used to transmit control signals. The bandwidth used to transmit the control signals is of lower quality than the bandwidth of the common communication channel. For example, the bandwidth used to transmit the control signals may have a lower capacity for information transfer and/or a lower signal-to-noise ratio. The control signals may be low rate frequency shift keying (FSK) modulated signals.

The bandwidth used to transmit the control signals is bandwidth that is not used to transmit data (in these embodiments, uplink data). A reason for the bandwidth being unused for data transmission may be the oversampling that is done in order to relax the requirements for the analog (anti-aliasing) filter before the analog-to-digital converter (ADC 54).

The communication channel may be referred to as a primary information-bearing channel. A bandwidth of one or more hardware components of an MS or AP may include the bandwidth of the communication channel and also further bandwidth that may be described as spare communication capacity. The spare communication capacity may be any capacity that is not used by the primary information-bearing channel. In some embodiments, the spare capacity may not be used for reasons such as lower signal to noise ratio (which in some circumstances may be insufficient for data transmission) than the primary information-bearing channel, or lower capacity than the capacity of the primary information-bearing channel.

In further embodiments, for example embodiments described below with reference to FIGS. 6 and 7, bandwidth that is not used for data transmission may be used to transmit any suitable operational signals, for example control signals or timing signals. Operational signals may be signals relating to, for example, a transmission process or the operation of a device.

In some embodiments, the bandwidth that is used to transmit the operational signals is bandwidth that is at a higher frequency than a communication channel used to transmit data. In some embodiments, the bandwidth that is used to transmit the operational signals is bandwidth that is at a lower frequency than a communication channel. In some embodiments, the bandwidth that is used to transmit the operational signals is in a frequency range that lies between frequency ranges used by two or more communication channels.

The bandwidth used to transmit the operational signals may be of a lower quality than the bandwidth used for data transmission.

The channel used to transmit the operational signals may be of better or equal quality than the communication channel.

FIG. 6 is a schematic diagram showing a bandwidth region 200 and an operational channel 210. The bandwidth region 200 may be referred to as a communication channel. In the present embodiment, the bandwidth region 200 is used to transmit uplink data which is modulated using OFDM. In the present embodiment, the operational channel 210 is used to transmit a timing signal. The operational channel 210 may be referred to as a timing channel or pilot channel.

In the present embodiment, the spectrum of an OFDM data signal fills the frequency range below 20 MHz. In other embodiments, the bandwidth region 200 may be any bandwidth region configured to transmit a data signal (for example, any suitable communication channel which may be any suitable uplink or downlink channel).

In the present embodiment, the timing channel 210 is a narrowband channel at 40 MHz. The timing channel 210 selected to be in a frequency region of lower quality than the bandwidth region 200. The frequency of the timing channel is selected in dependence on a system clock frequency as described further below.

Only the bandwidth region 200 and timing channel 210 are shown in FIG. 6 for clarity. However, the MS 222 may also be configured to transmit control signals over one or more control channels. The or each control channel may be higher or lower in frequency than the timing channel 210. The timing channel 210 and control channel or channels may occupy bandwidth that is lower quality than bandwidth 200. In other embodiments, the MS 222 may be configured to transmit any suitable operational signals over any operational channels that are outside the bandwidth region 200, and may be of lower quality than bandwidth region 200.

FIG. 7 is a block diagram of an embodiment of an optical wireless system. The optical wireless system comprises an MS 222 that is configured to transmit OFDM data over the bandwidth region 200 and to transmit a timing signal over the operational channel 210, and an AP 220 configured to receive the OFDM data and timing signal. In other embodiments, the optical wireless system may comprise any suitable number of MSs and/or APs. In the present embodiment, the MS 222 is configured to send the timing signal and the AP 220 is configured to receive the timing signal. In other embodiments, the AP 220 is configured to transmit a timing signal and the MS 222 is configured to receive the timing signal from the AP 220.

In an embodiment described below with reference to FIGS. 6 and 7, bandwidth that is not used for data transmission is used to transmit a timing signal (which may be referred to as a pilot or pilot signal) which may allow the recovery of a transmitter clock of MS 222 at a receiver of AP 220. Having a transmitter clock at the receiver side may have various uses.

The MS 222 of the present embodiment has a system clock frequency of 160 MHz. The timing channel 210 is placed at 40 MHz because the ratio of 40 MHz and 160 MHz is a rational number. In other embodiments, the timing channel 210 may be placed at any frequency between 20 MHz and 80 MHz as long as the ratio of the timing channel frequency (which may be called a pilot frequency) to the system clock, f_p/f_sys, is a rational frequency.

MS 222 comprises an OFDM transmitter 230, an upsampling and interpolation module 232, a DAC 234 and an LED 236. In use, the OFDM transmitter generates an OFDM signal, which is passed to the upsampling and interpolation module 232. The upsampling and interpolation module 232 upsamples the OFDM signal by a factor of 4. In other embodiments, any suitable upsampling factor may be used.

A timing signal 233 (which may be called a pilot or pilot signal) is added to the OFDM signal after upsampling and interpolation of the OFDM signal carrying the data. The timing signal 233 comprises a sinusoid at 40 MHz. The timing signal is unmodulated. The timing signal 233 is derived from a system clock signal 238 of the MS 222.

The combined OFDM signal and timing signal 233 are passed to the DAC 234. The DAC 234 also receives the system clock signal 238. The DAC 234 converts the OFDM signal and timing signal into an analog signal. LED 236 is modulated in accordance with the analog signal and emits modulated light.

Line 239 of FIG. 7 represents a transmission of light over an optical channel from MS 222 to AP 220.

AP 220 comprises a low pass filter (LPF) 240, an analog to digital converter (ADC) 242, a downsampling module 244 and an OFDM receiver 246. AP 220 also comprises a bandpass filter (BPF) 250, a phase locked loop 252, a glitch-free clock selector 254 and an oscillator (OSC) 256.

The LPF 240, ADC 242, downsampling module 244 and OFDM receiver 246 may be considered to form a normal receiver chain for receiving OFDM data. In use, the LPF 240 filters out frequencies above those of bandwidth region 200, i.e. frequencies above 20 MHz. The ADC 242 converts the analog signal transmitted over optical channel 239 into a digital signal. The digital signal is downsampled by 4 by the downsampling module 244. The downsampled signal is received by the OFDM receiver 246.

The BPF 250, PLL 252, glitch-free clock selector 254 and oscillator 256 are used for recovery of the clock signal. The BPF 250 has a 40 MHz centre frequency. In use, the BPF 250 extracts the timing signal from the signal received over the optical channel 239. The extracted signal is fed to the PLL 252. The PLL 252 filters out jitter and multiplies the frequency of the timing signal by four. The PLL 252 outputs an output signal which may be considered to be a recovered clock signal.

The glitch-free clock selector 254 is used to select between the recovered clock signal and a clock signal provided by the internal oscillator 256. In other embodiments, any suitable clock selector may be used. The glitch-free clock selector 254 outputs a clock signal that comprises either the recovered clock signal or the clock signal provided by the internal oscillator 256.

When the PLL 252 is locked, the recovered clock signal is used as the system clock for the AP 220. When the timing signal is too weak or not present, the internal oscillator 256 is used for the system clock. The switch over between the clocks may be free of jitter. Jitter may comprise small random rotations of the constellation due to imperfect clock drift compensation.

If the timing signal is not present, the receiver may use clock drift tracking. If the timing signal is present, the clock drift tracking of the receiver may be turned off. Turning off clock drift tracking may reduce or eliminate any jitter and/or noise that is caused by the clock drift tracking.

By using the recovered clock signal, a clock of the receiving device (which in this embodiment is AP 220) may be synchronised with a clock of the transmitting device (which in this embodiment is MS 222). There may be a performance gain at the receiver (which in this embodiment is AP 220) due to the synchronous operation which may result from receiving the timing signal.

In some circumstances, channel estimation may be made more robust against noise by averaging a channel estimation result over several packets. In the receiver of the present embodiment, a long sequence of a preamble of a packet is used for channel estimation. If the receiver clock is free running (not related to a clock of the transmitter) then averaging of long sequences from multiple packets may not be possible. A random sample phase resulting from the free running receiver clock may cause the long sequences to be very different, and it may not be possible to average them. By transmitting the timing signal, it may be the case that long sequences of multiple packets can be successfully averaged, resulting in better channel estimation.

In some embodiments, fine amplitude estimation and/or fine timing estimation may be used. Fine amplitude estimation or fine timing estimation may use the long sequence in a 802.11a derived receiver. Amplitude estimation and/or timing estimation may be made more accurate by the synchronisation due to the timing signal. In some circumstances, amplitude estimation and/or timing estimation may be made more robust against noise.

In some circumstances, demodulation may be improved. The presence of the timing signal may reduce or eliminate jitter. The reduction or elimination of jitter may improve demodulation.

In other embodiments, the MS 222 of FIG. 7 may be replaced by any transmitting device, for example any MS or AP. The AP 220 may be replaced by any receiving device, for example any MS or AP.

In some embodiments, a timing signal is provided continuously. The oscillator 256 and clock drift tracking may be used only if the timing signal becomes too weak to detect. In some embodiments, a timing signal is provided at intervals and the oscillator 256 and clock drift tracking are used outside those intervals.

If a receiver is used that does not support the timing signal, there may not be any compatibility issues. Since the timing channel 210 is outside the uplink channel bandwidth 200, it may be filtered out.

In some embodiments, power for the timing signal is taken away from the power for the data signal. The amplitude of the data signal may be reduced slightly in order to accommodate the timing signal without clipping. In some circumstances, if timing signal power of more than a few percent of the total power would be required in order to provide a timing signal, the timing signal may be omitted. In some circumstances, a performance gain resulting from the provision of a timing signal may justify the transmit power that is used to provide the timing signal.

In embodiments, a frequency region outside a bandwidth (for example bandwidth region 200) that is used for transmitting data may be used to provide any suitable operational signals, for example timing signals and/or control signals.

In some embodiments, a frequency region outside a data transmission bandwidth is used to provide an interrupt signal. With the MAC of the present embodiment, throughput may go down and latency increase with the number of users. If there are many users, in some circumstances idle users may not be polled unless they request something. A user that has been idle may send an out of band interrupt to the AP. The AP may then resume polling that user.

A frequency region outside a bandwidth (for example, bandwidth 200) that is used for transmitting data may be used to provide a timing signal and/or control signals. Control signals may be modulated, for example FSK modulated. A timing signal may be unmodulated.

Techniques have been described for signalling important media access control information in baseband wireless communication systems with a specific application to optical wireless communications and visible light communications.

Although embodiments have been described that include optical wireless networks, any other suitable wireless networks may be used in other embodiments. For example, embodiments may comprise or be implemented on RF wireless networks, microwave wireless networks, or wireless networks in which messages are transmitted and/or received using any other suitable frequency of electromagnetic radiation. For example, embodiments may be implemented in millimetre wave or terahertz networks.

In RF embodiments, for example embodiments implemented in millimetre wave or terahertz networks, wireless network devices may have antennas or other front-end components which have characteristics that fall-off with frequency. The system bandwidth may be limited by the antenna and/or front-end components. Data communications may be transmitted in a high-quality part of the system bandwidth and control signals may be transmitted via control channels in a lower-quality part of the system bandwidth.

Embodiments have been described for the uplink of a full-duplex system. In other embodiments, methods as described above may be used in half-duplex systems. In further embodiments, control channels outside the band of a common downlink channel may be used in the downlink of a full-duplex system. By using control channels in downlink, control information may be decoupled from user data. Decoupling control information from user data may in some circumstances provide reduced complexity in data frame structures, reduced control complexity and/or increased security of the control information.

In some embodiments in which control channels outside the band of a common uplink channels are used in uplink, decoupling control information from user data may provide reduced complexity in data frame structure, reduced control complexity and/or increased security of the control information in uplink.

Although embodiments have been described which include a visible light downlink and an infrared uplink, any other suitable frequency of electromagnetic radiation may be used for the downlinks and uplinks. For example, in the case of optical wireless embodiments, UV light may be used as well as or instead of either visible or infrared light, by using suitable LEDs or other light sources.

Whilst components of the embodiments described herein may be implemented in software, it will be understood that any such components may be implemented in hardware, for example in the form of ASICs or FPGAs, or in a combination of hardware and software. Similarly, some or all of the hardware components of embodiments described herein may be implemented in software or in a suitable combination of software and hardware.

Whilst components of the embodiments described herein are implemented in analog hardware, it will be understood that such components may be implemented in digital hardware or in a combination of analog and digital hardware. Whilst components of the embodiments described herein are implemented in digital hardware, it will be understood that such components may be implemented in analog hardware or in a combination of analog and digital hardware. Any one of the components in the system may be implemented either in analog or in digital electronics.

It will be understood that the present invention has been described above purely by way of example, and modifications of detail can be made within the scope of the invention. Each feature disclosed in the description, and (where appropriate) the claims and drawings may be provided independently or in any appropriate combination.

What is claimed is:

1. A method of communication in an optical wireless network, the optical wireless network comprising a first device, a plurality of further devices, and a common communication channel usable by any one of the further devices for sending data to the first device;
the method comprising:
sending, by at least one of the further devices, at least one control signal to the first device via at least one control channel; and
allocating, by the first device, the common communication channel to one or more of the further devices, wherein the allocating is in response to the at least one control signal;
wherein the sending of the control signal or at least one of the control signals by the further device or at least one of the further devices is substantially simultaneous with the sending of data via the common communication channel.

2. A method according to claim 1, wherein the or each control channel is selected to have lower quality than the common communication channel.

3. A method according to claim 2, wherein lower quality comprises at least one of a) and b):
a) lower capacity for information transfer;
b) lower signal-to-noise ratio.

4. A method according to claim 1, further comprising receiving by the first device the at least one control signal and the data from the other one of the further devices, wherein the receiving of the at least one control signal does not interrupt the receiving of the data from the other one of the further devices.

5. A method according to claim 1, wherein the sending of the at least one control signal to the first device via the at least one control channel comprises:
sending by a first one of the plurality of further devices a first control signal via a first control channel; and
sending by a second one of the plurality of further devices a second control signal via a second, different control channel.

6. A method according to claim 5, wherein the sending of the first control signal and the sending of the second control signal are substantially simultaneous.

7. A method according to claim 1 wherein allocating the common communication channel to one or more of the further devices comprises allocating a respective communication resource on the communication channel to each of the one or more further devices.

8. A method according to claim 1, wherein the common communication channel occupies a communication frequency band, and wherein the or each control channel occupies a respective control frequency band outside the communication frequency band.

9. A method according to claim 1, wherein the at least one control channel comprises a plurality of control channels, each control channel corresponding to a respective one of the plurality of further devices.

10. A method according to claim 9 wherein the at least one control signal comprises control signals sent by a plurality of the further devices via a corresponding plurality of control channels; and
wherein, for the or each control signal, the first device is configured to determine which one of the further devices sent the control signal in dependence on the control channel on which the control signal was sent.

11. A method according to claim 1 further comprising receiving by the first device an additional control signal from an additional device via an additional control channel, the additional control signal comprising a request to join the wireless network.

12. A method according to claim 11 further comprising assigning by the first device a control channel to the additional device in response to the request to join the network.

13. A method according to claim 1 wherein the at least one control signal comprises at least one request to send (RTS).

14. A method according to claim 1, further comprising sending, on the at least one control channel by at least one of the plurality of devices, control signals comprising at least one of a RTS, a request to join the network, an acknowledgement (ACK), transmission priority information, transmission link information, quality of service information, system requirements information.

15. A method according to claim 1, wherein the common communication channel comprises an uplink channel.

16. A method according to claim 1, wherein the common communication channel and a further communication channel form a full duplex connection between the first device and the plurality of further devices.

17. A method according to claim 16, wherein the further communication channel comprises a downlink channel, and wherein the first device is configured to send data to the plurality of further devices via the downlink channel.

18. A method according to claim 17, wherein the first device is further configured to send control signals to the plurality of further devices via the downlink channel.

19. A method according to claim 18, wherein the allocating by the first device of the common communication channel comprises sending control signals to the plurality of further devices via the downlink channel, the control signals comprising information about the allocation.

20. A method according to claim 19, wherein the first device is further configured to send control signals to the plurality of further devices via a plurality of downlink control channels.

21. A method according to claim 16, wherein the further communication channel comprises a visible light downlink, and the communication channel and plurality of control channels each comprise an infrared uplink.

22. A method according to claim 1 wherein the first device comprises an Access Point and each of the further devices comprises a Station, optionally a Mobile Station.

23. A method according to claim 1, the method further comprising sending, by one of the further devices, a timing signal to the first device via an operational channel, or sending by the first device a timing signal to one of the further devices via the operational channel.

24. A method according to claim 23, wherein the timing signal is obtained from a clock of the one of the further devices, or wherein the timing signal is obtained from a clock of the first device.

25. A method according to claim 23, the method further comprising synchronising, by the first device, a clock of the first device with the timing signal, or synchronising, by the one of the further devices, a clock of the one of the further devices with the timing signal.

26. A method according to claim 23, wherein the method further comprises selecting, by a clock selector of the first device, the timing signal or a clock signal from a clock of the first device, or selecting, by a clock selector of the one of the further devices, the timing signal or a clock signal from a clock of the one of the further devices.

27. An optical wireless communication system comprising:
a first device; and
a plurality of further devices configured to send at least one control signal to the first device via at least one control channel, and to send data to the first device via a common communication channel usable by any one of the further devices;
wherein the first device is configured to allocate the common communication channel to one or more of the further devices, wherein the allocating is in response to the at least one control signal; and
wherein the sending of the control signal or at least one of the control signals by the further device or at least one of the further devices is substantially simultaneous with sending of data via the common communication channel.

28. (canceled)

29. An optical receiver configured to receive from at least one of a plurality of further devices at least one control signal via at least one control channel and to allocate a common communication channel to one or more of the further devices in response to the at least one control signal, wherein the receiving by the receiver of the control signal or at least one of the control signals is substantially simultaneous with receiving of data by the receiver via the common communication channel.

30. An optical transmitter configured to send at least one control signal to a first device via at least one control channel to request an allocation of a common communication channel, wherein the common communication channel is usable by any one of a plurality of transmitters;
and to send data to the first device via the common communication channel;
wherein the sending of the control signal or at least one of the control signals by the transmitter via the at least one control channel is substantially simultaneous with sending of data via the common communication channel.

31. A method of communication in an optical wireless network, the optical wireless network comprising:
a first device;
a second device;
a communication channel for sending data from the second device to the first device;
and
an operational channel for sending operational signals from the second device to the first device,
the method comprising:
sending by the second device data to the first device via the communication channel; and
sending by the second device at least one operational signal to the first device via the operational channel, wherein the sending of the at least one operational signal via the operational channel is substantially simultaneous with the sending of data via the communication channel.

32-37. (canceled)

38. An optical wireless communication system comprising:
a first device; and
a second device configured to send data to the first device via a communication channel and to send at least one operational signal to the first device via an operational channel; and
wherein the sending of the at least one operational signal via the operational channel is substantially simultaneous with the sending of data via the communication channel.

39-41. (canceled)

42. A method according to claim 1, wherein the control channel uses a frequency or range of frequencies that are too high for use as the common communication channel.

43. A method according to claim 1, wherein the frequency or range of frequencies used for the control channel are too high to comply with at least one of a technical standard, a regulatory standard, or a desired signal quality if used for the common communication channel.
